(19) United States
(12) Patent Application Publication
(10) Pub. No.: US 2023/0264346 A1
(43) Pub. Date: Aug. 24, 2023

(54) LINEAR BODY SUPPORTING STRUCTURE AND ROBOT

(71) Applicant: FANUC CORPORATION, Yamanashi (JP)

(72) Inventor: Kazuki Hamano, Minamitsuru-gun, Yamanashi-ken (JP)

(21) Appl. No.: 18/043,539

(22) PCT Filed: Sep. 8, 2021
(86) PCT No.: PCT/JP2021/033043

§ 371 Date: Feb. 28, 2023

(30) Foreign Application Priority Data
Sep. 14, 2020 (JP) 2020-153918

(51) Int. Cl. B25J 9/10

(52) U.S. Cl. CPC B25J 9/106

(57) ABSTRACT

This linear body supporting structure comprises: two links coupled to each other so as to be rotatable about a predetermined axis line; a linear body laid across the two links; and an elastic body that is directly or indirectly fixed to at least one of the two links at a position away from the axis line and that directly or indirectly supports the linear body.

The present invention relates to a linear body supporting structure and a robot, and in particular, to a linear body supporting structure for alleviating twisting of a linear body, and a robot.

### BACKGROUND ART

An industrial robot, etc. generally includes various long linear bodies or umbilical members such as cables and/or air tubes containing signal lines and power lines to facilitate its operation. In the conventional forming of the umbilical members in joints of robots. It is difficult to secure a long service life due to twisting of the umbilical members generated by rotation of the joint and due to wear generated by friction between the umbilical members and peripheral members. In addition, with the recent demand for high-speed robot operations, considerable man-hours and costs are necessary in order to determine the method of arranging wires in the umbilical member, the material of the wire, and the distance between clamps for the umbilical members, etc. In this context, the following documents are known as disclosing techniques related to the present application.

Patent Literature 1 discloses a cable handling device which protects and holds cables arranged between two relative pivoting members of an industrial robot. The cable handling device includes a sliding shaft arranged in at least one of the two relative pivoting members in a lateral direction transverse to the longitudinal direction of the relative pivoting members, and a clamp member which grips the cable and slides on the sliding shaft. The sliding shaft holds the clamp member slidably on a substantially circular circumference centered on the center of rotation of the relative pivoting member, whereby twisting of the cable due to the pivoting action of the relative pivoting member is eliminated.

Patent Literature 2 discloses a robot having: a robot arm having a first and second frames pivotably connected about a joint axis; a cable arranged along side surfaces of the first and second flumes, a first fixing member configured to connect the cable to the aide surface of the first frame; a second fixing member Configured to connect the cable to the side surface of the second frame; a holding member configured to hold a portion of the cable between the first and second fixing members: and a support mechanism configured to restrict movement of the holding member in the axial direction of the joint axis, and support the holding member so that the holding member can move in a direction orthogonal to the axial direction of the joint axis following bending motion of the cable.

### CITATION LIST

### Patent Literature

[PTL 1] JP 1989(H01)-306193 A
[PTL 2] JP 2014-030893 A

### SUMMARY OF INVENTION

### Technical Problem

The purpose of the present invention is to alleviate twisting of an umbilical member at a rotation shaft part, in view of the above problems.

### Solution to Problem

One aspect of the present disclosure provides an umbilical member supporting structure comprising two links rotatably connected to each other about a predetermined axis; an umbilical member arranged to be laid across the two links; and an elastic bode directly or indirectly fixed to at least one of the two links at a position separated trunk the axis, and configured to directly or indirectly support the umbilical member.

### Advantageous Effects of Invention

According to the one aspect of the present disclosure, in response to rotation of the ling, the elastic body passively deforms in the direction in which the umbilical member intends to escape, secures a twisting distance of the umbilical member, and suppresses the rapid twisting of the umbilical member or reduces the twist amount thereof. By virtue of this, the twisting of the umbilical member can be relaxed. On the other hand, since the clastic body limits the movement range of the umbilical member to some extent, wear of the umbilical member clue to the contact between it and surrounding objects can be avoided, whereby the life span of the umbilical member is improved. By improving the life spars of the umbilical member, it is possible to use a low-cost umbilical member which could not be used until now.

### BRIEF DESCRIPTION OF DRAWINGS

FIG. 1 is a perspective view of a robot having an umbilical member supporting structure according to an embodiment.

FIG. 2 is a cross-sectional view of a second link along a line II-II.

FIG. 3 is a perspective view of an example of an elastic body.

FIG. 4 is a perspective view of an example of a supporting member.

FIG. 5A is a cross-sectional view of the second link along a line V-V, showing an example of a motion of the clastic body.

FIG. 5B is a cross-sectional view of the second link along the line V-V, showing an example of a motion of the elastic body.

FIG. 6 is a perspective view of the umbilical member supporting structure applied to a robot having another configuration.

FIG. 7 is a perspective view of an example of an elastic body.

FIG. 8 is a perspective view of a modification of an elastic body.

FIG. 9 is a perspective view of another modification of an elastic body.

FIG. 10 is a perspective view of a further modification of an elastic body.

FIG. 11 is a perspective view of a still further modification of an elastic body.

FIG. 12 is a perspective view of a still further modification of an elastic body.

FIG. 13 is a perspective view of a still further modification of an elastic body.

FIG. 14 is a partial longitudinal sectional view of another modification of an umbilical member supporting structure.

### DESCRIPTION OF EMBODIMENTS

The embodiments of the present disclosure will be described in detail below with reference to the attached drawings. In the drawings, identical or similar constituent elements have been assigned the same or similar reverence signs. Further, the embodiments described below do not limit the technical scope of the invention described in the claims or the definitions of the terms. In addition, it should be noted that the term “directly” as used herein means that objects are in direct contact, and the term “indirectly” as used herein means that objects are in indirect contact through another component.

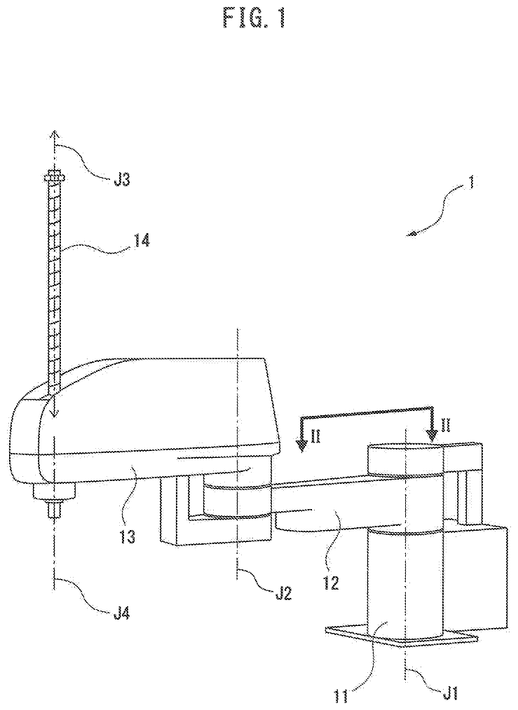

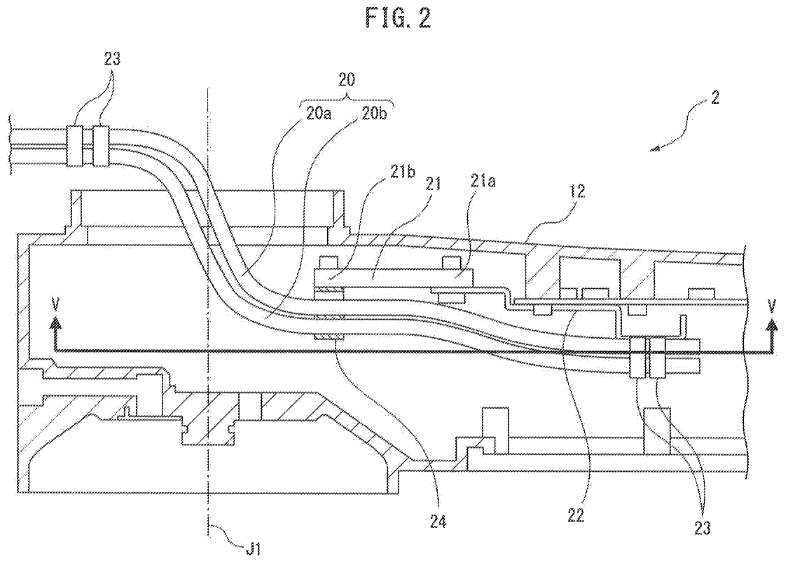

FIG. 1 is a perspective view of a robot 1 having an umbilical member supporting structure according to an embodiment. The robot 1 is, for example, a horizontal articulated robot (SCARA robot), and has a first link 11, a second link 12, a third link 13, and a tip shaft 14. For example, the first link 11 is a hollow base the second link 12 and the third link 13 are hollow arm members, and the tip shaft 14 is a hollow hall screw spline. The first link 11 and the second link 12 are rotatable connected to each other about a J1 axis, and the second link 12 and the third link 13 are rotatably connected to each other about a J2 axis. The third link 13 and the tip shaft 14 are connected to each other so that they can move up and down along a J3 axis and can rotate about a J4 axis relative to each other. The J1 to J4 axes are parallel to each other. Actuators (not shown) such as electric motors and speed reduction gears are respectively arranged on the J1 to J4 axes, and cables such as signal lines and power lines are connected to the actuators. A tool (not shown) such as a suction hand or a screwdriver is detachably attached to the tip shall 14, and a cable, an air tube, etc., is connected to the tool. In order to avoid contact with peripheral equipment and a human, a linear body or umbilical member such as the cable and air tube (see FIG. 2) is preferably arranged, for example, in the first link 11, the second link 12, the third link 13, the tip shaft 14, and the tool, etc., SG that the umbilical member is laid across the inside of the links and/or the shaft. In addition, the umbilical member is connected to a controller (not shown) configured to control the robot 1 and the tool. Herein, members constituting the rotating shaft portion such as the first link 11, the second link 12, the third link 13, the tip shaft 14, and the tool are referred to as “links”.

FIG. 2 is a cross-sectional view of the second link 12 taken along a lire II-II. An umbilical member support structure 2 is applied to the rotating shaft portion between the two links. For example, the umbilical member support structure 2 has the first link 11 (see FIG. 1) and the second link 12 rotatable connected to each other about the J 1 axis; the umbilical member 20 arranged to be laid across the first link 11 and the second link 12; and an elastic body 21 indirectly fixed to the second link 12 at a position separated from the J1 axis, and configured to indirectly support the umbilical member 20.

The umbilical member 20 includes, for example, a cable 20a and/or an air tube 20b, etc. In order to prevent wear due to contact with peripheral members, the umbilical member 20 is preferably fixed at a predetermined position to each of the first link 11 and the second link 12 with a fastener 23 such as a binding band. By positioning the elastic body 21 configured to directly or indirectly support the umbilical member 20 between these two fixed positions, twisted portions of the umbilical member 20 can be dispersed.

For example, the elastic body 21 is made of an elastomer such as rubber. The elastic body 21 may have a fixed end 21a which is indirectly fixed to the second link 12, and a free end 21b which indirectly supports the umbilical member 20 at a position closer to the J1 axis than the fixed end 21a. For example, the fixed end 21a of the elastic body 21 is fixed to a fixing member 22 such as a sheet metal with a screw, etc., and is fixed to the second link 12 via the fixing member 22. However, the fitted end 21a may be directly fixed to the second link 12. For example, a supporting member 24 configured to support the umbilical member 20 is attached to the free end 21b of the elastic body 21 with a screw, etc. However, the elastic body 21 may directly support the umbilical member 20. It is preferable that the supporting member 24 slidably support the umbilical member 20 while restricting the movement range thereof, whereas the supporting member 24 may constrain the umbilical member 20 so that it does not move.

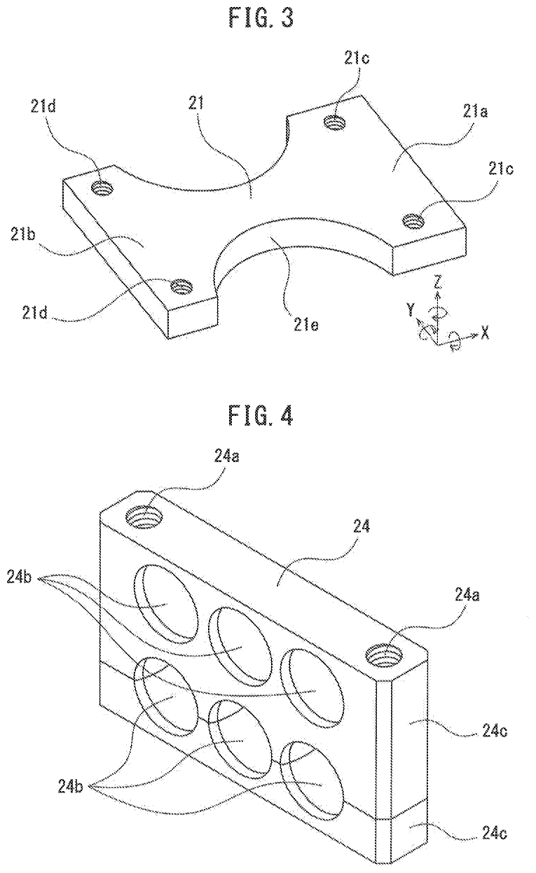

FIG. 3 is a perspective view showing an example of the elastic body 21. For example, the elastic body 21 is formed like a plate. A fixed end 21a of the elastic body 21 has a fixing hole 21c for fixing the elastic body 21 to the second link 12 or the fixing member 22 with a screw, etc. The tree end 21b of the elastic body 21 has a fixing hole 21d for fixing the supporting member 24 to the elastic body 21 with a screw, etc. Moreover, the elastic body 21 preferably has a constricted portion 21e between the fixed end 21a and the free end 21b. The constricted portion 21e is preferably formed in the direction of deformation of the clastic body 21, and facilitates deformation of the elastic body 21 about the X, Y and Z axes. The elastic body 21 passively deforms in the direction in which the umbilical member 20 intends to escape or move, and secures a certain amount of twisting distance of the umbilical member 20 to suppress rapid twisting of the umbilical member 20, or reduce the amount of Twist thereof.

FIG. 4 is a perspective view showing an example of the supporting member 24. For example, the supporting member 24 is formed as a flat plate and has a fixing hole 24a for fixing the supporting member 24 to the elastic body 21 with a screw, etc. The supporting member 24 also has one or more supporting holes 24b for supporting the umbilical member 20, and may have two or more supporting pieces 24c which can be separated at a position of the support hole 24b so that the umbilical member 20 can be easily inserted into the supporting hole 24b. When the supporting member 24 has a plurality of support holes 24b, the plurality of support holes 24b are preferably arranged along one separation line.

The supporting hole 24b preferably has an inner diameter slightly larger than an outer diameter of the umbilical member 20. Thereby, the supporting member 24 can slidably support the umbilical member 20 while restricting the movement range thereof to some extent. Further, the inner diameter of the supporting hole 24b may have an inner peripheral surface, the inner diameter of which is the smallest at a midpoint in the axial direction of the supporting hole 24b, and gradually increase: toward both ends m the axial direction. Thereby, the contact area between the umbilical member 20 and the inner peripheral surface of the supporting hole 24b can be reduced. Furthermore, in order to reduce the coefficient of friction of the supporting hole 24b, the supporting member 24 itself is made of a material with a low coefficient of friction, e.g., fluororesin such as tetrafluoroethylene (polytetrafluoroethylene: PTFE), or polyolefin resin, etc. Alternatively, the inner peripheral surface of the supporting hole 24b may be coated with a material having a low coefficient of friction.

By restricting the movement range of the umbilical member 20 to some a extent by means of the supporting member 24, the umbilical member 20 is restrained from being violently moved according to the rotation of the link, and the umbilical member 20 can be prevented from coming into contact with peripheral objects and becoming worn. In addition, since the supporting member 24 slidably supports the umbilical member 20, the load acting on the umbilical member 20 according to the rotation of the link can be reduced. Furthermore, by reducing the coefficient of friction of the supporting hole 24b, wear of the umbilical member 20 due to friction between it and the supporting member 24 can be suppressed.

It should be noted that the above configuration of the umbilical member supporting structure 2 is merely an example, and that other configurations can also be adopted. For example, the umbilical member supporting structure 2 may be applied to the rotation shaft portion between the second link. 12 and the third link 13, instead of the rotation shaft portion between the first link H and the second link 12. Further, the umbilical member supporting structure 2 may be arranged outside the robot 1 instead of being arranged inside the robot 1. Furthermore, the umbilical member supporting structure 2 may be applied to a rotating shaft portion of another type of robot, for example, a vertical multi-joint robot or a humanoid, as described below. Alternatively, the umbilical member supporting structure 2 may be applied to a rotation shaft of another machine such as a vehicle and an aircraft. Also, the elastic body 21 may be fixed to both of the two links one by one, or may be fixed to only one link. Further, the elastic body 21 may not indirectly support the umbilical member 20 via the supporting member 24, instead, may have a supporting hole for supporting the umbilical member 20 so that the elastic body 21 itself directly support the umbilical member 20.

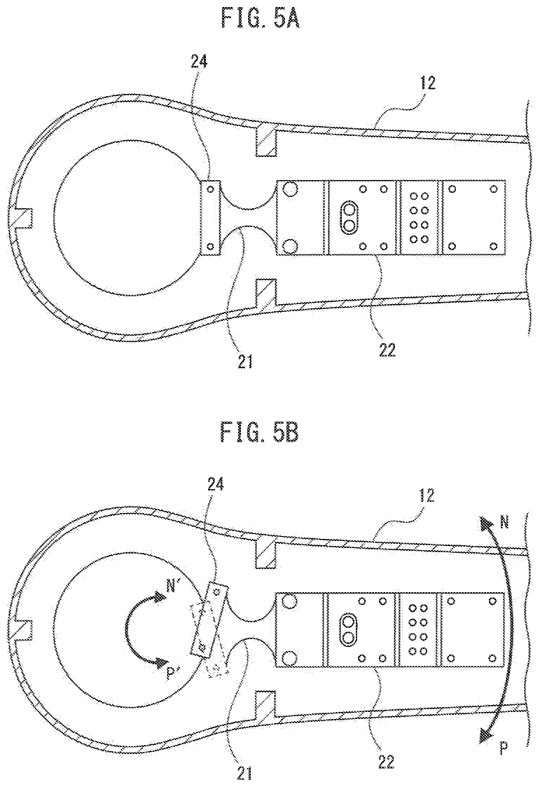

FIGS. 5A and 5B are cross-sectional views of the second link 12 along a line V-V, showing an example of the motion of the elastic body 21. It should be noted that the umbilical member 20 is not illustrated in these figures, this being so that the motion of the elastic body 21 can be easily understood. FIG. 5A shows a state in which the elastic body 21 is not deformed, and PICT. 5B shows a state in which the elastic body 21 is deformed according to the rotation of the second link 12. For example, when the second link 12 rotates in a forward rotation direction P, the elastic body 21 passively deforms in a direction P′ (e.g., around the J1 axis) in which the umbilical member 20 intends to escape or move. On the other hand, when the second link 12 rotates in a reverse rotation direction N, the elastic body 21 passively deforms in a direction N′ (e.g., around the J1 axis) in which the umbilical member 20 intends to escape or move.

As such, the elastic body 21 passively deforms in the direction in which the umbilical member 20 intends to escape in accordance with the rotation of the second link 12, and secures the twisting distance of the umbilical member 20 to suppress rapid twisting of the umbilical member 20, or reduce the amount of twist of the umbilical member 20. Also, by arranging the elastic body 21 between the two fixed positions by the fasteners 23 (see FIG. 2), the twisted portions of the umbilical member 20 can be dispersed. Thereby, the twisting of the umbilical member 20 can be relaxed. On the other hand, since the elastic body 21 limits the movement range of the umbilical member 20 to some extent, it is possible to prevent the umbilical member 20 from wearing due to contact between it and peripheral objects. As a result, the life of the umbilical member 20 is improved. By improving the life of the umbilical member 20, it becomes possible to employ an inexpensive umbilical member, which could not be used until now. In contrast, when the elastic body 21 is not provided, the umbilical member 20 is concentrated and excessively twisted in the vicinity of the two fixed positions by the fasteners 23. In addition, the umbilical member 20 is worn out due to it corning into contact with peripheral objects as a result of the umbilical member 20 being violently moved.

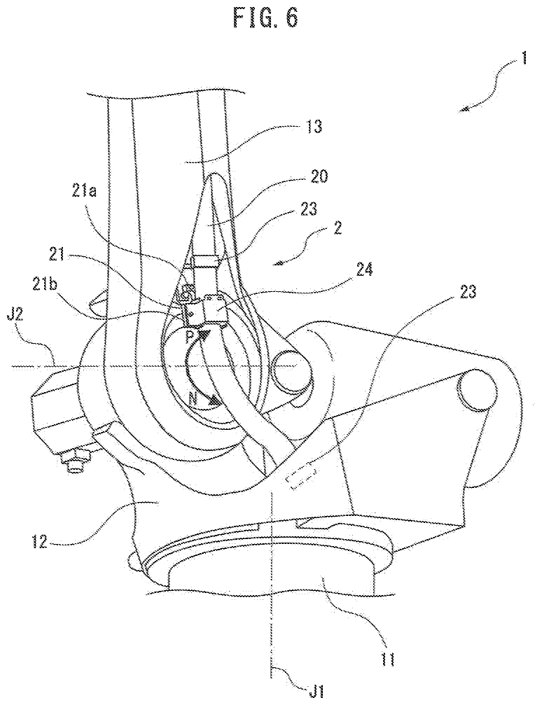

FIG. 6 is a perspective view of an umbilical member supporting structure 2 applied to a robot 1 of another aspect. The robot 1 is, for example, a vertical articulated robot, and at least has a first link 11, a second link 12, and a third link 13. For example, the first link 11 is a hollow base, the second link 12 and the third link 13 are hollow arm members. The first link 11 and the second link 12 are rotatably connected to each other about a J1 axis, and the second link 12 and the third link 13 are rotatably connected to each other about a J2 axis. The J1 axis is perpendicular to the J2 axis. Actuators such as electric motors and speed reduction gears are respectively arranged on the J1 and J2 axes, and cables such as signal lines and power lines are connected to the actuators. A tool (not shown) such as a suction hand or a screwdriver is detachably attached to a tip of the robot, and a cable, an air tube, etc., is connected to the tool. A linear body or umbilical member 20 such as the cable and air tube is laid across, for example, from the inside of the first link 11 through the outside of the second link 12 and the third link 13 to the inside of the third link 13. In addition, the umbilical member is connected to a controller (not shown) configured to control the robot 1 and the tool.

The umbilical member supporting structure 2 of this example is applied to the rotating shaft portion between the second link 12 and the third link 13. For example, the umbilical member supporting structure 2 has the second link 12 and the third link 13 rotatably connected to each other about the J2 axis, the umbilical member 20 laid across the second link 12 and the third link 13, and an elastic body 21 directly fixed to the third link 13 at a position away from the J2 axis and directly supporting the umbilical member 20.

The umbilical member 20 includes, for example, a cable and/or an air tube, etc. In order to prevent wear due to contact with peripheral members, the umbilical member 20 is preferably fixed at a predetermined position to each of the second link 12 and the third link 13 with a fastener 23 (not shown) such as a binding band. By positioning the elastic body 21 configured to directly or indirectly support the umbilical member 20 between these two fixed positions, twisted portions of the umbilical member 20 can be dispersed.

For example, the elastic body 21 is made of an elastomer such as rubber. The elastic body 21 may have a fixed end 21a which is indirectly fixed to the third link 13, and a free end 21b which indirectly supports the umbilical member 20 at a position closer to the J2 axis than the fixed end 21a. For example, the fixed end 21a of the elastic body 21 is directly fixed to the third link 13 with a screw, etc. For example, a supporting member 24 configured to support the umbilical member 20 is attached to the free end 21b of the elastic body 21 with a screw, etc. However, the elastic body 21 may directly support the umbilical member 20. For example, a supporting member 24 configured to support the umbilical member 20 is attached to the free end 21b of the elastic body 21 with a screw, etc.

The supporting member 24 is, for example, a C-shaped or U-shaped fastener. The supporting member 24 has fixing holes 24a for fixing the supporting member 24 to the elastic body 21 with a screw, etc. The supporting member 24 may constrain the umbilical member 20 so that the umbilical member 20 does not Move, but may slidably support the umbilical member 20.

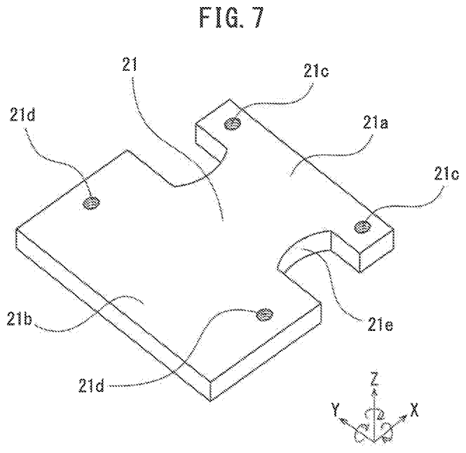

FIG. 7 is a perspective view showing an example of the elastic body 21. For example, the elastic body 21 is formed like a plate. A fixed end 21a of the elastic body 21 has a fixing hole 21c for fixing the elastic body 21 to the third link 13 with a screw, etc. The tree end 21b of the elastic body 21 has a fixing hole 21d for fixing the supporting member 24 to the elastic body 31 with a screw, etc. Moreover, the elastic body 21 preferably has a constricted portion 21e between the fixed end 21a and the free end 21b. The constricted portion 21e is preferably formed in the direction of deformation of the elastic body 21. The constricted portion 21e facilitates deformation of the elastic body 21 about the X, Y and Z axes. The elastic body 21 passively deforms in the direction in which the umbilical member 20 intends to escape or move, and secures a certain amount of twisting distance of the umbilical member 20 to suppress rapid twisting of the umbilical member 20, or reduce the amount of twist of the umbilical member 20.

Referring to FIG. 6 again, for example, when the third link 13 rotates in a forward rotation direction 1′ or a reverse rotation direction N, the elastic body 21 passively deforms in a direction (e.g., around the J2 axis or perpendicular to the sheet of FIG. 6) in which the umbilical member 20 intends to escape or move. As such, the elastic body 21 passively deforms in the direction in which the umbilical member 20 intends to escape in accordance with the rotation of the third link 13, and secures the twisting distance of the umbilical member 20 to suppress rapid twisting of the umbilical member 20, or reduce the amount of twist of the umbilical member 20. Also, by arranging the elastic body 21 between the two fixed positions by the fasteners 23, the twisted portions of the umbilical member 20 can be dispersed. Thereby, the twisting of the umbilical member 20 can be relaxed. On the other hand, since the elastic body 21 limits the movement range of the umbilical member 20 to some extent, it is possible to prevent the umbilical member 20 from wearing due to contact between it and peripheral objects. As a result, the life of the umbilical member 20 is improved. By improving the life of the umbilical member 20, it becomes possible to employ an inexpensive umbilical member, which could not be used until now.

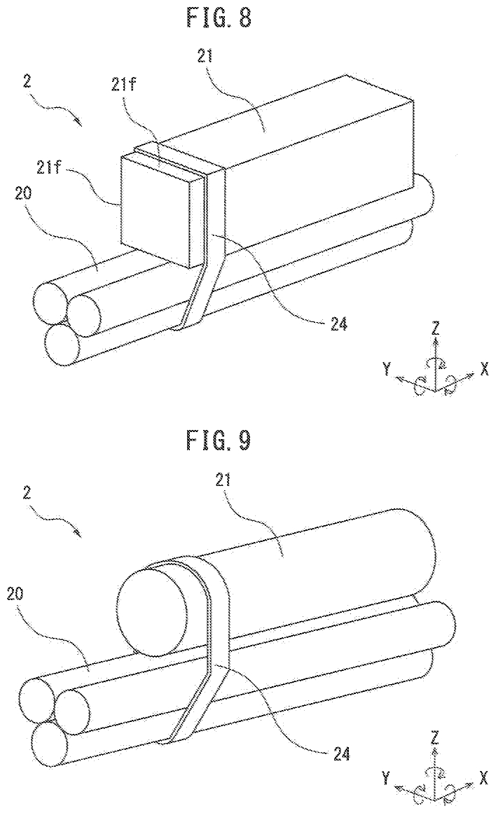

FIG. 8 is a perspective view showing a modification of the elastic body 21. The elastic body 21 of this example is different from the one described above in that it is a square bar. The cross section of the elastic body 21 is preferably square, which facilitates deformation of the elastic body 31 around the X, Y and Z axes. Furthermore, in order to facilitate deformation of the elastic body 21, it is preferable to arrange the elastic body 21 so that one surface 21f of the square bar is parallel to the rotation axis between the two links. The supporting member 24 for supporting the umbilical member 20 is attached to the free end of the elastic body 21. The supporting member 24 is, for example, a fastener such as a binding band. The supporting member 24 may constrain the umbilical member 20, but may support it in a slidable manner. In order to reduce the coefficient of friction of the umbilical member 20, a tape with a low coefficient of friction, e.g., fluororesin such as tetrafluoroethylene (polytetrafluoroethylene: PTFE), or polyolefin, resin, etc., may be adhered to the umbilical member 20.

FIG. 9 is a perspective view showing another modification of the elastic body 21. The elastic body 21 of this example is a round bar. The cross section of the elastic body 21 is preferably a perfect circle, which allows deformation of the elastic body 21 around the X, Y and Z axes. The supporting member 24 for summing the umbilical member 20 is attached to the free end of the elastic body 21. The supporting member 24 is, for example, a fastener such as a binding rand. The supporting member 24 may constrain the umbilical member 20, but may support the umbilical member 20 in a slidable manner. In order to reduce the coefficient of friction of the umbilical member 20, a tape with a low coefficient of friction, e.g., fluororesin such as tetrafluoroethylene (polytetrafluoroethylene: PTFE), or polyolefin resin, etc., may be adhered to the umbilical member 20.

FIG. 10 is a perspective view showing a further modification of the elastic body 21. The elastic body 21 of this example is a square bar, and has a constricted portion 21e between the fixed end 21a and the free end 21b. The constricted portion 21e is preferably formed in the direction of deformation of the elastic bod y 21. €n this example, the constricted portion 21e is formed on each of four faces of the square bar. The constricted portion 21e facilitates deformation of the elastic body 21 about the X, Y and Z axes. The supporting member 24 for supporting the umbilical member 20 is attached to the free end of the elastic body 21. The supporting member 24 is, for example, a fastener such as a binding hand. The supporting member 24 may constrain the umbilical member 20, but may support it in a slidable manner. In order to reduce the coefficient of friction of the umbilical member 20, a tape with a low coefficient of friction, e.g., fluororesin such as tetrafluoroethylene (polytetrafluoroethylene: PTFE), or polyolefin resin, etc., may be adhered to the umbilical member 20.

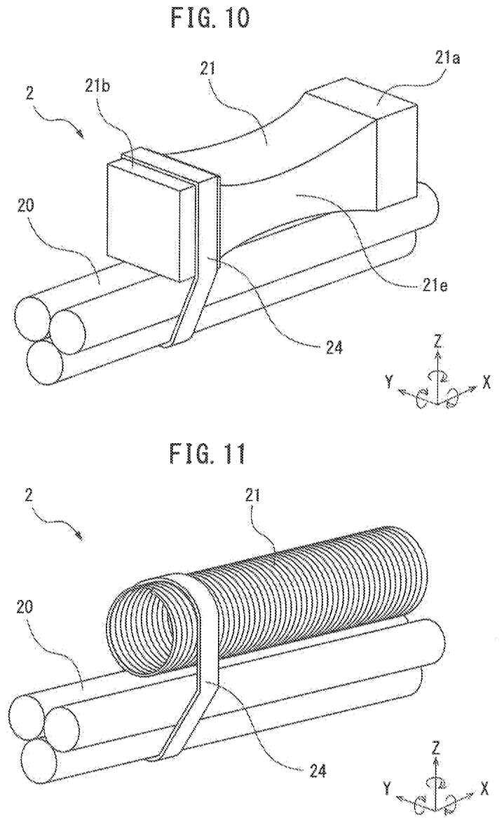

FIG. 11 is a perspective view showing a still further modification of the elastic body 21. The elastic body 21 of this example is different from the one described above in that it is a coil spring. For example, the coil spring is made of metal, etc. By forming the coil spring from metal, degradation of the elastic body 21 can be suppressed. The coil spring facilitates deformation of the elastic body 21 about the X, Y and Z axes. The supporting, member 24 for supporting the umbilical member 20 is attached to the free end of the elastic body 21. The supporting member 24 is, for example, a fastener such as a binding band. The supporting member 24 may constrain the umbilical member 20, but may support it in a slidable manner. In order to reduce the coefficient of friction of the umbilical member 20, a tape with a low coefficient of friction, e.g., fluororesin such as tetrafluoroethylene (polytetrafluoroethylene: PTFE), or polyolefin resin, etc., may be adhered to the umbilical member 20.

FIG. 12 is a perspective view showing a still further modification of the elastic body 21. The elastic body 21 of this example is different from the one described above in that it is a coil spring, and the umbilical member 20 is inserted into the coil spring. The elastic body 21 may constrain the umbilical member 20, but may support it in a slidable manner. For example, the coil spring may have an inner diameter slightly larger than the outer diameter of the umbilical member 20. In order to reduce the coefficient of friction of the umbilical member 20, a tape with a low coefficient of friction, e.g., fluororesin such as tetrafluoroethylene (polytetrafluoroethylene: PTFE), or polyolefin resin, etc., may be adhered to the umbilical member 20.

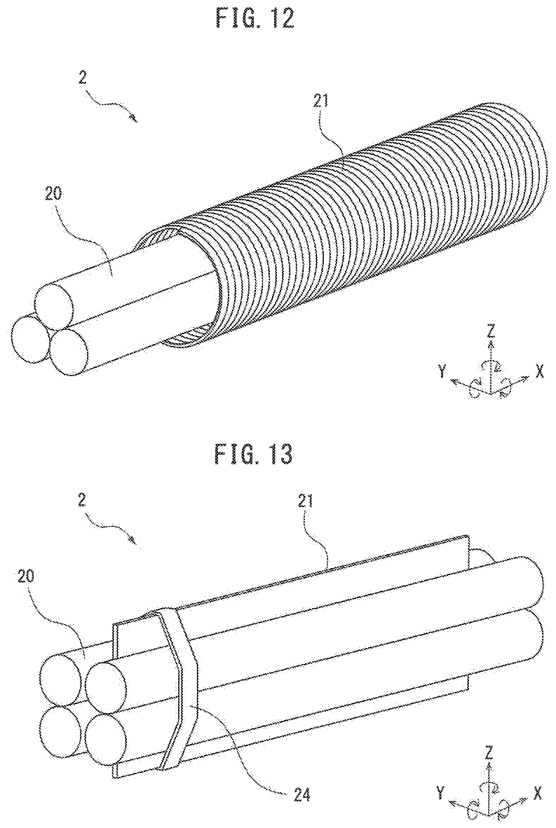

FIG. 13 is a perspective view showing a still further modification of the elastic body 21. The elastic body 21 of this example is different front the one described above in that it is a leaf spring. The leaf spring facilitates deformation of the elastic both 21 about one of the X, Y and axes (for example about the Z axis). In order to facilitate deformation of the elastic body 21, the elastic body 21 may be arranged so that the surface of the leaf spring is parallel to the rotation axis between the Ewe) links. The supporting member 24 for supporting the umbilical member 20 is attached to the free end of the elastic body 21. The supporting member 24 is, for example, a fastener such as a binding band. The supporting member 24 may constrain the umbilical member 20, but may support it in a slidable manner. In order to reduce the coefficient of friction of the umbilical member 20, a tape with a low coefficient of friction, e.g., fluororesin such as tetrafluoroethylene (polytetraflouroethylene: PTFE), or polyolefin resin, etc., may be adhered to the umbilical member 20 or the elastic body 21. Alternatively, the plate-like supporting member 24 as described with reference to FIG. 4 may be attached to both sides of the leaf spring to support the umbilical member 20.

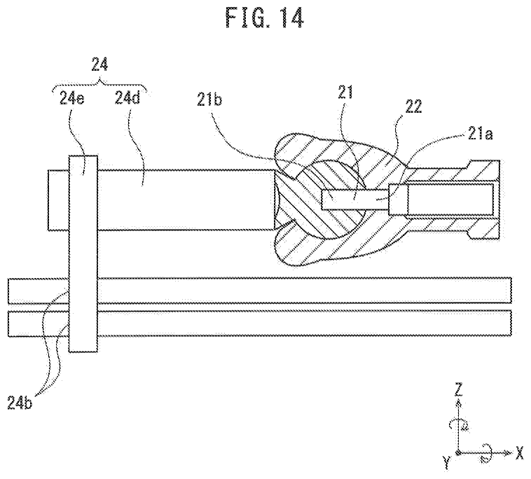

FIG. 14 is a partial longitudinal sectional view showing another modification of the umbilical member supporting structure 2. In the umbilical member supporting structure 2 of this example is different from the one described above in that the elastic body 21 is an elastomer such as rubber, the fixed end 21a of the elastic body 21 is fixed to the fixing member 22 having a glenoid, and the supporting member 24 having a joint head is attached to the free end 21b of the elastic body 21. For example, the fixing member 22 and the supporting member 24 are made of metal, resin, etc. When the joint head of the supporting member 24 rotates in the glenoid of the fixing member 22, the restoring force of the elastic body 21 causes the supporting member 24 to return to the reference position (the position shown in FIG. 14). The supporting member 24 may have, fir example, a supporting piece 24d having the joint head and a supporting piece 24e which is attached to the supporting piece 24d and supports the umbilical member 20. The supporting piece 24e may be, for example, a fastener such as a binding band, or may be a supporting member provided with the support hole 24b as described with reference to FIG. 4. The supporting member 24 may constrain the umbilical member 20, but it 3S preferable to support the umbilical member 20 in a slidable manner. In addition, the fixing fixing member 22 may have the joint head instead of the glenoid, and the supporting member 24 may have the glenoid instead of the joint head. Alternatively, the supporting piece 24d may be the elastic body 21 such as an elastomer, and the fixing member 22 and the supporting member 24 may have a joystick-like connecting structure.

According to the above embodiments, the elastic both 21 passively deforms in the direction in which the umbilical member 20 intends to escape in accordance with the rotation of the link, and secures the twisting distance of the umbilical member 20 to suppress rapid twisting of the umbilical member 20, or reduce the amount of twist of the umbilical member 20. Thereby, the twisting of the umbilical member 20 can be relaxed. On the other hand, since the elastic body 21 limits the movement range of the umbilical member 20 to some extent, it is possible to prevent the umbilical member 20 from wearing due to contact between it and peripheral objects. As a result, the life of the umbilical member 20 is improved. By improving the life of the umbilical member 20, it becomes possible to employ an inexpensive umbilical member which could not be used until now.

Although the various embodiments are described herein, it should be noted that the present invention is hoot limited to the above embodiments, and various modifications can be performed within the scope of the camas.

### REFERENCE SIGNS LIST

1 robot
2 umbilical member supporting structure
11 first link
12 second link
13 third link
14 tip she
20 umbilical member
20a cable
20b air tube
21 elastic body
21a fixed end
21b free end
21c, 21d fixing hole
21e constricted portion
21f surface
22 fixing member
23 fastener
24 supporting memo r
24a fixing hole
24b supporting hole
24c-24e supporting m piece
J1-J4 axis
P forward direction
N reverse direction P′,N′ direction in which umbilical member intends to escape

1. An umbilical member supporting structure comprising:
two links rotatably connected to each other about a predetermined axis;
an umbilical member arranged to be laid across the two links; and
an elastic body directly or indirectly fixed to at least one of the two links at a position separated from the axis, and configured to directly or indirectly support the umbilical member.

2. The umbilical member supporting structure according to claim 1, wherein the elastic body has a fixed end which is directly or indirectly fixed to the link, and a free end which directly or indirectly supports the umbilical member at a position closer to the axis than the fixed end.

3. The umbilical member supporting structure according to claim 2, wherein the elastic body has a constricted portion between the fixed end and the free end.

4. The umbilical member supporting structure according to claim 2, wherein a supporting member configured to support the umbilical member is attached to the free end.

5. The umbilical member supporting structure according to claim 4, wherein at least one of the supporting member and the elastic body constrains the umbilical member or slidably supports the umbilical member while restricting a movement range of the umbilical member.

6. The umbilical member supporting structure according to claim 1, wherein the elastic body is an elastomer, a coil spring or a leaf spring.

7. The umbilical member supporting structure according to claim 1, wherein the elastic body is a coil spring, and the umbilical member is inserted into the coil spring.

8. The umbilical member supporting structure according to claim 1, wherein the umbilical member is fixed to the two links at predetermined fixing positions, and the elastic body is positioned between the two fixing positions.

9. A robot having the umbilical member supporting structure according to claim 1.
